(19) United States
(12) Patent Application Publication
(10) Pub. No.: US 2023/0294896 A1
(43) Pub. Date: Sep. 21, 2023

(54) Trays For Food Products And Related Systems And Methods

(71) Applicant: Graphic Packaging International, LLC, Atlanta, GA (US)

(72) Inventors: Kate Jackson, Ashby-de-la-Zouch (GB); Jamie Skipper, Leicester (GB); Elliot Hithersay, Derbyshire (GB)

(21) Appl. No.: 18/121,121

(22) Filed: Mar. 14, 2023

Related U.S. Application Data
(60) Provisional application No. 63/319,872, filed on Mar. 15, 2022.
(60) Provisional application No. 63/415,705, filed on Oct. 13, 2022.

(51) Int. Cl. B65D 77/04; B65D 5/20; B65D 5/56; B65D 77/20; B31B 50/26

(52) U.S. Cl. CPC B65D 77/042; B65D 5/20; B65D 5/566; B65D 77/2024; B31B 50/26; B31B 2120/402

(57) ABSTRACT

A tray for holding one or more food products includes a plurality of panels including a central panel, at least one attachment panel in at least partial face-to-face contact with a portion of the central panel, at least one side panel foldably connected to a respective panel of the plurality of panels, at least one end panel foldably connected to a respective panel of the plurality of panels, and at least one bottom panel foldably connected to a respective panel of the plurality of panels, the at least one side panel intersecting the at least one end panel to at least partially form a sidewall of the tray extending around an interior of the tray, the at least one bottom panel at least partially forming a bottom wall of the tray, and tray engaging features for at least partially supporting another tray in the interior of the tray.

### CROSS-REFERENCE TO RELATED APPLICATIONS

This application claims the benefit of each of U.S. Provisional Patent Application No. 63/319,872, filed on Mar. 15, 2022, and U.S. Provisional Patent Application No. 63/415,705, filed on Oct. 13, 2022.

### INCORPORATION BY REFERENCE

The disclosures of each of U.S. Provisional Patent Application No. 63/319,872, filed on Mar. 15, 2022, U.S. Provisional Patent Application No. 63/415,705, filed on Oct. 13, 2022, U.S. Design patent application Ser. No. 29/886,759, filed on Mar. 13, 2023, U.S. Provisional Patent Application No. 63/159,015, filed on Mar. 10, 2021, U.S. patent application Ser. No. 17/690,204, filed on Mar. 9, 2022, U.S. patent application Ser. No. 16/532,819, filed on Aug. 6, 2019, U.S. Provisional Patent Application No. 62/851,932, filed May 23, 2019, U.S. Provisional Patent Application No. 62/796,716, filed Jan. 25, 2019, U.S. Provisional Patent Application No. 62/715,520, filed Aug. 7, 2018, U.S. patent application Ser. No. 16/037,425, filed Jul. 17, 2018, U.S. Provisional Patent Application No. 62/649,159, filed Mar. 28, 2018, U.S. Provisional Patent Application No. 62/643,914, filed Mar. 16, 2018, U.S. patent application Ser. No. 15/654,814, filed Jul. 20, 2017, U.S. Provisional Patent Application No. 62/365,635, filed Jul. 22, 2016, and U.S. patent application Ser. No. 12/992,131, filed Feb. 11, 2011, and PCT Patent Application No. PCT/GB/09/50506, filed May 13, 2009, are hereby incorporated by reference for all purposes as if presented herein in their entirety.

### BACKGROUND OF THE DISCLOSURE

The present disclosure relates to blanks, containers, trays, constructs, and various features and methods for forming a container from a blank. More specifically, the disclosure is generally directed to systems of cooperating trays.

### SUMMARY OF THE DISCLOSURE

According to one aspect, the disclosure is generally directed to a tray for holding one or more food products, the tray comprising a plurality of panels comprising a central panel, at least one attachment panel in at least partial face-to-face contact with a portion of the central panel, at least one side panel foldably connected to a respective panel of the plurality of panels, at least one end panel foldably connected to a respective panel of the plurality of panels, and at least one bottom panel foldably connected to a respective panel of the plurality of panels, the at least one side panel intersecting the at least one end panel to at least partially form a sidewall of the tray extending around an interior of the tray, the at least one bottom panel at least partially forming a bottom wall of the tray, and tray engaging features for at least partially supporting another tray in the interior of the tray.

According to another aspect, the disclosure is generally directed to a blank for forming a tray for holding one or more food products, the blank comprising a plurality of panels comprising a central panel, at least one attachment panel for being in at least partial face-to-face contact with a portion of the central panel when the tray is formed from the blank, at least one side panel foldably connected to a respective panel of the plurality of panels, at least one end panel foldably connected to a respective panel of the plurality of panels, and at least one bottom panel foldably connected to a respective panel of the plurality of panels, the at least one side panel for intersecting the at least one end panel to at least partially form a sidewall of the tray formed from the blank and extending around an interior of the tray formed from the blank, the at least one bottom panel for at least partially forming a bottom wall of the tray formed from the blank, and tray engaging features for at least partially supporting another tray in the interior of the tray formed from the blank.

According to another aspect, the disclosure is generally directed to a method of forming a tray for holding one or more food products, the method comprising obtaining a blank comprising a plurality of panels comprising a central panel, at least one attachment panel, at least one side panel foldably connected to a respective panel of the plurality of panels, at least one end panel foldably connected to a respective panel of the plurality of panels, and at least one bottom panel foldably connected to a respective panel of the plurality of panels, and tray engaging features, positioning the at least one side panel and the at least one end panel to at least partially form a sidewall at least partially extending around an interior of the tray and such that the tray engaging features are positioned for at least partially supporting another tray in the interior of the tray, and positioning the at least one bottom panel to at least partially form a bottom wall of the tray.

According to another aspect, the disclosure is generally directed to a system comprising a first tray comprising a plurality of panels comprising a central panel, at least one attachment panel in at least partial face-to-face contact with a portion of the central panel, at least one side panel foldably connected to a respective panel of the plurality of panels, at least one end panel foldably connected to a respective panel of the plurality of panels, and at least one bottom panel foldably connected to a respective panel of the plurality of panels, the at least one side panel intersecting the at least one end panel to at least partially form a sidewall of the tray extending around an interior of the tray, the at least one bottom panel at least partially forming a bottom wall of the tray, and tray engaging features for at least partially supporting another tray in the interior of the tray. The system further comprises a second tray at least partially supported in the interior of the first tray by the tray engaging features.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a blank for forming a first tray of a system according to a first exemplary embodiment of the disclosure.

FIG. 2 is a schematic view of an apparatus for processing a blank and/or tray that can be used with exemplary embodiments of the present disclosure.

FIG. 3 is a plan view of a blank for forming a second tray of a system according to the first exemplary embodiment of the disclosure.

FIG. 4 is an assembly view of system of a first tray formed from the blank of FIG. 1 and a second tray formed from the blank of FIG. 3 according to the first exemplary embodiment of the disclosure.

FIG. 5 is a perspective view of the assembled system of FIG. 4.

FIG. 5A is a perspective view of the assembled system of FIG. 4 further provided with a lidding film and a liner applied thereto.

FIG. 6 is a plan view of a blank for forming a first tray of a system according to a second exemplary embodiment of the disclosure.

FIG. 7 is an assembly view of system of a first tray formed from the blank of FIG. 6 and a second tray formed from the blank of FIG. 3 according to the second exemplary embodiment of the disclosure.

FIG. 8 is a perspective view of the assembled system of FIG. 7.

FIG. 9 is a plan view of a blank for forming a first tray of a system according to a third exemplary embodiment of the disclosure.

FIG. 10 is a plan view of a blank for forming a second tray of a system according to the third exemplary embodiment of the disclosure.

FIG. 11 is an assembly view of system of a first tray formed from the blank of FIG. 9 and a second tray formed from the blank of FIG. 10 according to the third exemplary embodiment of the disclosure.

FIG. 12 is a perspective view of the assembled system of FIG. 11.

Corresponding parts are designated by corresponding reference numbers throughout the drawings.

### DETAILED DESCRIPTION OF THE EXEMPLARY EMBODIMENTS

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In one illustrated embodiment, the present disclosure relates to forming a container or tray for holding food items or various other articles. However, in other embodiments, the container or tray can be used to form other non-food containing articles or may be used for heating or cooking.

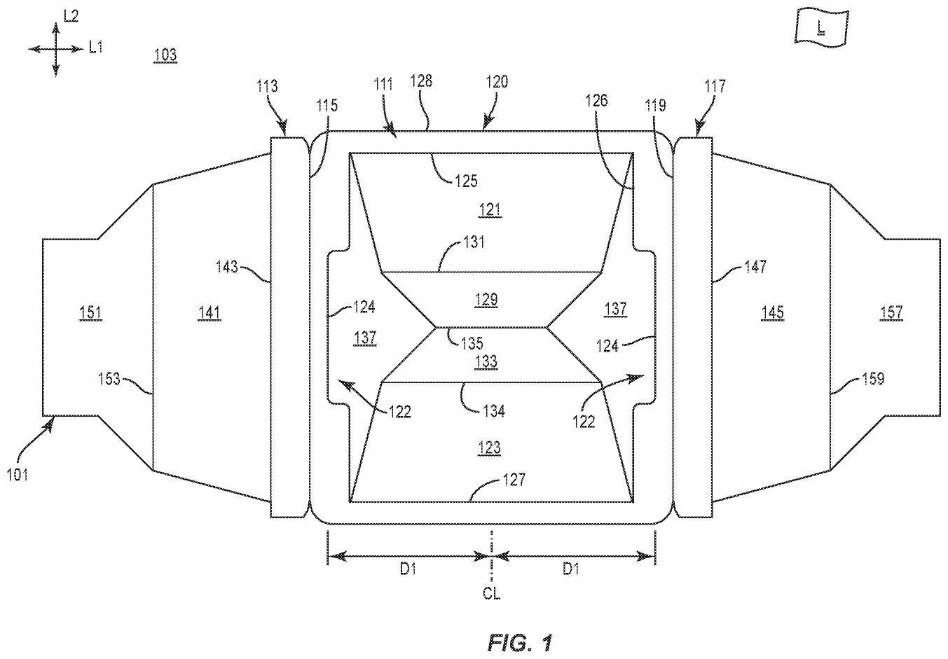

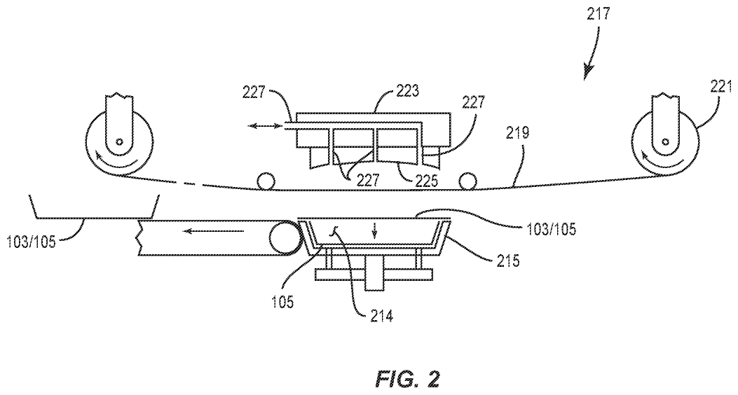

FIG. 1 illustrates an exterior surface 101 of a first blank 103 for forming a first tray 105 (FIG. 2) or other container according to a first exemplary embodiment of the disclosure. In one embodiment, the blank 103 comprises paperboard (e.g., solid bleached sulphate folding boxboard), or other suitable material that can be recyclable and/or suitable for use in an oven (not shown).

The blank 103 can be provided with a liner L that comprises a plastic layer such as polyethylene, a polyethylene terephthalate (PET) material, or any other thermoplastic material, or a bioplastic, such as vegetable oil or starch based plastics. In one embodiment, such liner can comprise polyethylene that can be softened and fused to the blank 103. In an alternative embodiment, a liner for being attached to the blank 103 can comprise PET or a similar material that is at least partially attached to the blank 103 by a heat seal layer (e.g., a thermoformable sealant grade transparent polyester packaging film, such as Mylar® XMPOL12 available from DuPont Teijin Films U.S. Limited Partnership of Hopewell, Virginia, or any suitable thermoformable sealant or adhesive, any suitable heat or pressure activated adhesive, or any other suitable material), wherein a PET liner can be more suitable for uses that require heating of the container in an oven.

Such a liner can be at least partially attached to the blank 103 for being positioned in contact with one or more food products held in the tray 105 (e.g., during heating). In one embodiment, after heating the food product, the blank 103 and an accompanying liner L can be separated to allow both the blank 103 and the liner to be recycled separately. Optionally, the blank 103 can be provided separately from the liner.

The blank 103 can be formed from a single ply of material, such as but not limited to paperboard, cardboard, paper, a polymeric sheet, and/or a laminate that includes more than one layer. In one embodiment, the blank 103 can include a microwave interactive layer (not shown) such as is common in MicroRite® containers available from Graphic Packaging International of Atlanta, GA. The microwave interactive layer can be commonly referred to as, or can have as one of its components, a susceptor, a foil, a microwave shield, or any other term or component that refers to a layer of material suitable for shielding microwave energy and/or causing heating in a microwave oven.

As shown in FIG. 1, the blank 103 has a longitudinal direction L1 and a lateral direction L2. In the illustrated embodiment, the blank 103 and tray 105 formed therefrom includes a plurality of panels comprising a central panel 111, a first attachment panel 113 foldably connected to the central panel 111 at a lateral fold line 115, and a second attachment panel 117 foldably connected to the central panel 111 at a lateral fold line 119. In some embodiments, the attachment panels 113, 117 can be considered portions of the central panel 111.

As shown, a peripheral region of the central panel 111 can form a flange 120 of the blank 103/tray 105. As shown, and as described further herein, the flange 120 can include a pair of opposed notches 122 (broadly, “first notch” and “second notch”) along portions of an interior edge 126 of the central panel 111. As shown, the interior edge 126 of the central panel 111 can at least partially define and/or circumscribe an opening 137.

In one embodiment, recessed portions 124 of the interior edge 126 of the central panel 111 can at least partially define respective notches 122 that can be spaced a distance D1 from a lateral centerline CL1 of the blank 103. As described herein, one or both of the notches 122 and associated features can be second tray engaging features or compartment forming features of the blank 103/tray 105.

The flange 120 can at least partially define an exterior edge 128 of the central panel 111. In some embodiments, the exterior edge 128 can at least partially be defined by the fold lines 115, 119.

The plurality of panels of the blank 103 and tray 105 formed therefrom can also include a first end panel 121 (broadly, “first panel”) foldably connected to the central panel 111 at a longitudinal fold line 125 (broadly, “first fold line”) extending along the opening 137 and a second end panel 123 (broadly, “first panel”) foldably connected to the central panel 111 at a longitudinal fold line 127 (broadly, respective “first fold line”) extending along the opening 137 for at least partially forming an interior of the tray 105.

A first bottom panel 129 can be foldably connected to the first end panel 121 at a longitudinal fold line 131, and a second bottom panel 133 (broadly, “fourth bottom panel”) can be foldably connected to the second side panel 123 at a longitudinal fold line 134. The bottom panels 129, 133 can be separable at a longitudinal cut 135.

The plurality of panels of the blank 103 and tray 105 formed therefrom can also include a first side panel 141 (broadly, “second panel”) foldably connected to the first attachment panel 113 at a lateral fold line 143 (broadly, “second fold line”) that is spaced apart from the opening 137, for example, via the first attachment panel 113, and a second side panel 145 (broadly, “second panel”) foldably connected to the second attachment panel 117 at a lateral fold line 147 (broadly, “second fold line”) spaced apart from the opening 137, for example, via the second attachment panel 117.

As also shown, a third bottom panel 151 (broadly, “second bottom panel”) can be foldably connected to the side panel 141 at a lateral fold line 153, and a fourth bottom panel 157 (broadly, “third bottom panel”) can be foldably connected to the side panel 145 at a lateral fold line 159.

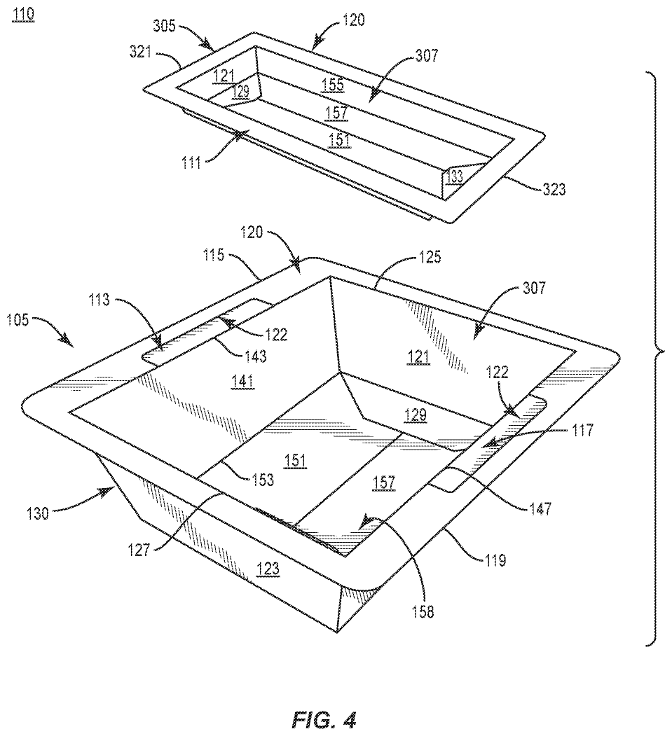

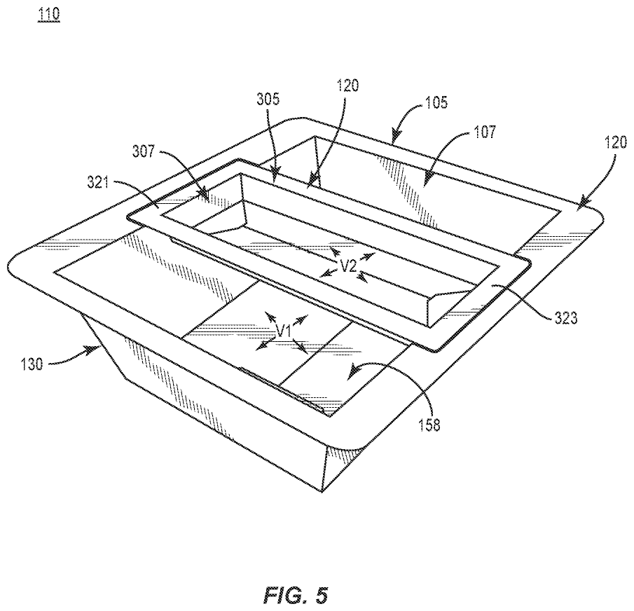

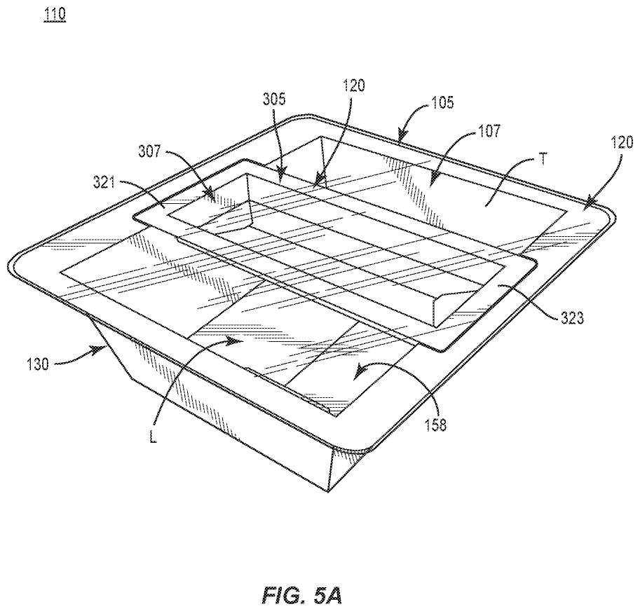

With additional reference to FIGS. 4 and 5, according to one embodiment, the attachment panels 113, 117 can be folded at the respective fold lines 115, 119 into at least partial face-to-face contact with respective portions of the central panel 111. In such an arrangement, the attachment panels 113, 117 can underlie the respective notches 122 along the flange 120/central panel 111 such that the attachment panels 113, 117 are at least partially exposed along the respective notches 122 so as to provide a supporting surface therealong or thereunder for another tray, as described further herein.

The bottom panels 129, 133 foldably connected to the respective end panels 121, 123 can be separated at the cut 135 and the end panels 121, 123 can be folded downwardly at the respective fold lines 125, 127 away from the central panel 111/opening 137.

The side panels 141, 145 can be folded inwardly at the respective fold lines 143, 147 so as to extend downwardly and away from the central panel 111 toward an engagement with the downwardly-depending end panels 121, 123. In this regard, an edge or surface of each of the side panels 141, 145 can intersect an edge or surface of the respective end panels 121, 123 to form a sidewall 130 of the tray 105 that extends at least partially around the interior 107 of the tray 105.

Furthermore, the bottom panels 151, 157 can be folded at the respective fold lines 153, 159 into a generally spaced and parallel arrangement with the central panel 111, with an edge or surface of each of the bottom panels 151, 157 intersecting an edge or surface of the respective end panels 121, 123. In such an arrangement, the bottom panels 129, 133 can be folded at the respective fold lines 131, 134 into at least partial face-to-face contact with the bottom panels 151, 157 to form a bottom wall 158 of the tray 105 and an interior compartment/first compartment/interior 107 of the tray 105.

The aforementioned arrangement of the tray 105 can be maintained via the attachment of the attachment panels 113, 117 to respective portions of the central panel 111 and/or the bottom panels 129, 133 to respective panels, and which can be at least partially maintained with an adhesive such as glue.

Furthermore, the overlapping arrangement of the end panels 121, 123 and side panels 141, 143 provides the tray 105 with a robust construction that resists deformation, bending, crushing etc. In this regard, one or more of the end panels 121, 123 and the side panels 141, 143 can be considered reinforcing features of the tray 105.

It will be understood that, in embodiments, a liner such as liner L can be applied to at least the interior 107 of the tray 105, and can overlie seams/points of intersection between the respective panels, e.g., such that the tray 105 has leak-resistant properties. The tray 105 is illustrated with the liner L applied to one or more interior surfaces thereof in FIG. 5A.

In one embodiment, the tray 105 can be formed similarly to the formation of the containers as shown and described in the incorporated-by-reference applications (e.g., the '425 Application, the '814 Application, and/or the '131 Application).

In an exemplary embodiment shown schematically in FIG. 2, the blank 103/tray 105 or a folded configuration thereof can be placed on a lower die 215 of a system 217 and a liner material or film sheet 219 (e.g., a polyethylene or PET web) can be fed from a supply roller 221 above the blank 103/folded blank 103. An upper die 223 has a heater plate surface 225 having a PTFE coating, for example a Teflon® coating. Alternatively, the heater plate surface 225 could have a coating of any suitable material or the coating could be omitted. As schematically shown in FIG. 4, the upper die 223 can include a plurality of holes or ducts 227 in the heater plate surface 225 for applying a vacuum and/or air pressure on the sheet 219. The lower die 215 and/or the upper die 223, including the ducts 227 and/or the heater plate 225, could be otherwise shaped, arranged, positioned, and/or configured without departing from the disclosure. For example, the heater plate 225 could be omitted and the heat could be alternatively applied to the sheet 219 (e.g., with a flow of hot air).

In the illustrated embodiment, the lower die 215 can hold the blank 103/folded blank 103 over a cavity 214 in the lower die 215 while supporting the blank 103/tray 105 at the central panel 111 and/or the attachment panels 113, 117 (e.g., so that the central panel 111 is facing upwardly). An initial vacuum can be applied to ducts 227 to draw the film sheet 219 toward the upper die 223, the upper die 223 can be heated to a suitable temperature to soften the film sheet 219 and/or to activate a heat seal layer. Instead of, or in addition to, the initial vacuum, air pressure under the film sheet 219 can be employed with similar or equal effect. Subsequently, the film sheet 219 can be forced downwardly (e.g., by air pressure applied by the ducts 227 and/or a vacuum applied from below the blank 103/tray 105).

The air pressure can move the film sheet 219 toward the blank 103/folded blank 103 and the lower die 215 can support the blank 103/tray 105 as the film sheet 219 is applied to portions of one or more of the flange 120, the end panels 121, 123, and the side panels 141, 143 to form the liner L. In one embodiment, the liner L can help retain the tray 105 in its tray shape after the liner L is applied to the blank 103/folded blank 103/tray 105. In one embodiment, the tray 105 can be ejected from the lower die 215 and transported away from the forming tool on a conveyor, for example.

In one embodiment, the tray 105 can be formed from the blank 103 and have the liner L applied thereto at a much higher rate than systems that separately form the tray 105 from the blank 103 blank and then place that formed tray 105 into the lower die 215. In one example, the tray 105 of the present embodiment can be formed from the blank 103 together with the liner L at a rate of approximately 200 trays per minute. The tray 105 could be otherwise formed without departing from the disclosure. For example, the tray 105 could be formed from the blank 103 prior to applying the liner L (e.g., prior to engaging the lower die 215).

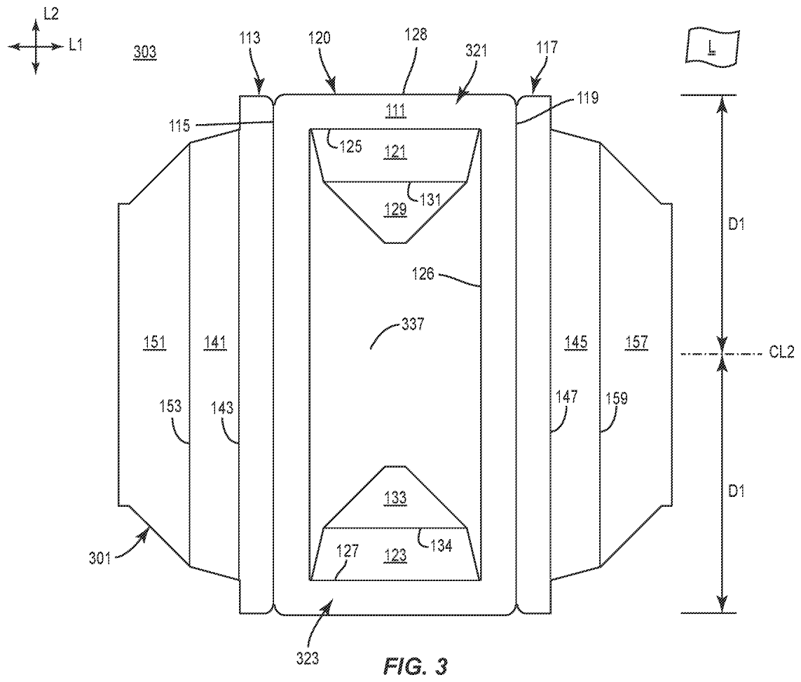

Referring to FIG. 3, an exterior surface 301 of a blank for forming a second tray 305 (FIG. 4, broadly, “container”) according to the first exemplary embodiment of the disclosure is generally designated 303. The blank 303 and tray 305 can have one or more features that are substantially similar to those described above with regard to the blank 103 and tray 105, and like or similar features are designated with like or similar reference numerals.

As shown, the blank 303 has the longitudinal axis L1 and the lateral axis L2, though is relatively more compact along the longitudinal direction than the blank 103 described above. As also shown, the side panels 121, 123 and bottom panels 129, 133 of the blank 303 are laterally shorter than those described above with regard to the blank 103 such that the bottom panels 129, 133 are spaced apart from one another along the lateral axis L2 with a generally bowtie-shaped opening 337 positioned therebetween.

Furthermore, laterally outer portions of the central panel 111 of the blank 303 form respective lateral ledges 321, 323 that have free edges spaced apart the distance D1 from a longitudinal centerline CL2 of the blank 303. As described further herein, the lateral ledges 321, 323 protrude laterally past portions of the tray 305 formed from the blank 303 formed by the panels 141, 145 for supporting the tray 305 on a portion of the tray 105 described above or another tray or structure.

The tray 305 can be formed from the blank 303 in a manner similar to that by which the tray 105 is formed from the blank 103 as described above. For example, the attachment panels 113, 117 can be folded at the respective fold lines 115, 119 into at least partial face-to-face contact with respective portions of the central panel 111, the end panels 121, 123 can be folded downwardly at the respective fold lines 125, 127 away from the central panel 111, and the side panels 141, 145 can be folded inwardly at the respective fold lines 143, 147 so as to extend downwardly and away from the central panel 111 toward an engagement with the downwardly-depending end panels 121, 123.

Furthermore, the bottom panels 151, 157 can be folded at the respective fold lines 153, 159 into a generally spaced and parallel arrangement with the central panel 111, with an edge or surface of each of the bottom panels 151, 157 intersecting an edge or surface of the respective bottom panels 129, 133. In such an arrangement, the bottom panels 129, 133 can be folded at the respective fold lines 131, 134 into at least partial face-to-face contact with the bottom panels 151, 157 to form a second interior compartment/the interior 307 of the tray 305. The aforementioned arrangement of the tray 105 can be maintained via the attachment of the attachment panels 113, 117 to respective portions of the central panel 111 and/or the bottom panels 129, 133 to respective panels and flaps, and which can be at least partially maintained with an adhesive such as glue.

It will be understood that a liner such as liner L (FIG. 1) can be applied to at least the interior 307 of the respective tray 305, and can overlie seams/points of intersection between the respective side panels and panels, e.g., such that the tray 305 can have leak-resistant properties. The liner L can be applied to one or more portions of the tray 305 in a manner similar to that described above with regard to the blank 103/tray 105, e.g., via the system 217 illustrated in FIG. 2.

With additional reference to FIGS. 4 and 5, engagement of the tray 105 and the tray 305 is illustrated according to one exemplary embodiment of the disclosure. As shown, the tray 305 can be oriented above the tray 105 and such that the ledges 321, 323 are aligned above the respective notches 122 along the flange 120 of the tray 105.

Thereafter, the tray 305 can be lowered into the interior 107 of the tray 105, with the ledges 321, 323 of the tray 305 supported on respective portions of the attachment panels 113, 117 of the tray 105 and abutting the edges of the central panel 111 that define the respective notches 122. In one embodiment, the edges of the central panel 111 that define the respective notches 122 can engage, e.g., via at least partial edge-to-edge contact, the ledges 321, 323 of the tray 305 to positionally stabilize the tray 305 with respect to the tray 105.

Furthermore, due to the generally recessed disposition of the tray 305 along the flange 120 of the tray 105, e.g., such that the ledges 321, 323 of the tray 305 are recessed in the respective notches 122 so as to be generally coplanar with the flange 120, the flange 120 of the tray 105 and the ledges 321, 323 of the tray 305 can be generally uninterrupted so as to provide a smooth and planar surface along which the lidding film can be applied to cover the interior 107 of the tray 105 as well as the interior 307 of the tray 305.

In one embodiment, the tray 305 can be sized and dimensioned so as to have a bottom that is supported above, e.g., spaced apart from, a bottom of the tray 105. In other embodiments, the bottom of the tray 305 can be in contact with the bottom wall 158 of the tray 105.

The aforementioned arrangement of the trays 105, 305 can provide a plurality of compartments, e.g., the respective interiors 107, 307 thereof that allow for separation of food products, e.g., for serving to one or more person, to prevent commingling thereof, to provide a main dish and a side dish, to utilize one or more of the compartments 107, 307 to hold a condiment, etc. In one embodiment, the interior 107 of the tray 105 can define a first interior volume V1 that is greater than a second interior volume V2 defined by the interior 307 of the tray 305. The trays 105, 305 can be provided together as a system 110. In other embodiments, the trays 105, 305 can be considered as being provided in an at least partially nested arrangement.

With additional reference to FIG. 5A, in one embodiment, a lid/lid structure such as a lidding film T can comprise packaging film that is a thin plastic layer used to preserve and protect a food item contained in the trays 105, 305 and can be removably attached to the respective flanges 120 of the trays 105, 305, e.g., defined by a portion of the respective central panels 111. In the system 110 described above, such a lidding film T can cover the flange 120 of the tray 105 along with the ledges 321, 323 of the tray 305 overlying respective portions of the flange 120 of the tray 105 so as to cover the interior 107 of the tray 105 along with the tray 307 of the tray 305 disposed therein. In some embodiments, a hermetic seal of the interior 107 of the tray 105 and/or the interior 307 of the tray 305 can be achieved by such engagement by a lidding film T.

Any plastic film, such as polyethylene, polypropylene, polyethylene terephthalate, polyvinylchloride, polyamide, and ethylene vinyl alcohol, or other suitable material, can be used for forming the lidding film that is sealed against the sealing surface of the flange/central panel 111. Further, adhesives can be used between the lidding film and the sealing surface of the flange/central panel without departing from the disclosure. In one embodiment, the sealing surface of the flange comprises an upper surface of the central panel 111 that is generally free from joints, creases, folds, pleats, edges, and other features that can make sealing a lidding film to the flange more difficult (e.g., that can reduce the smoothness of the flange). Accordingly, the upper surface of the central panel 111 in the trays 105, 305 of the illustrated embodiment can provide a superior sealing surface than a container that has features such as pleats or joints on its upper flange surface.

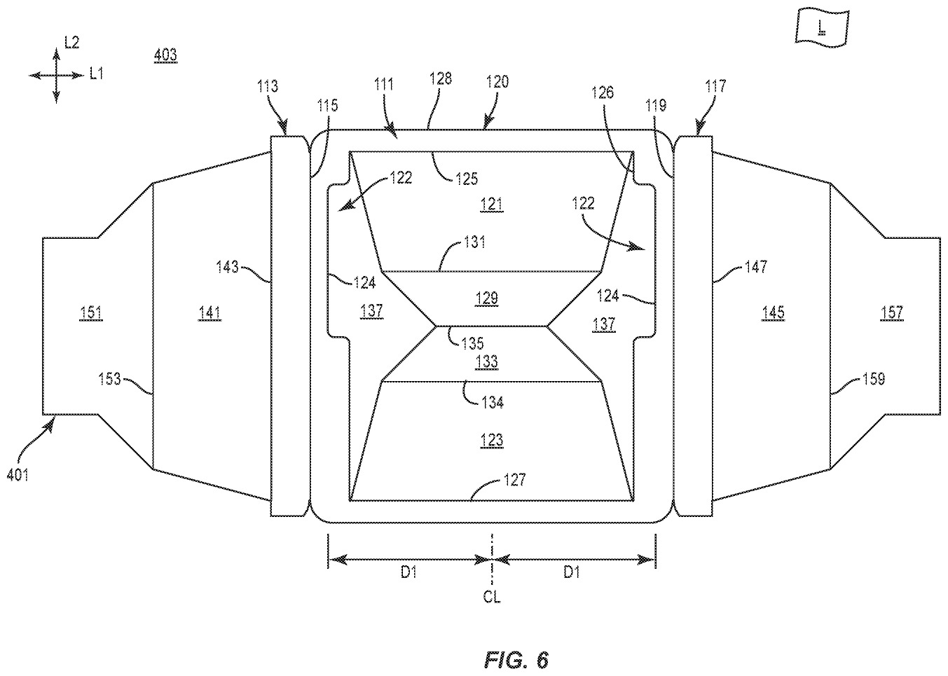

Referring to FIG. 6, an exterior surface 401 of a blank for forming a tray according to a second exemplary embodiment of the disclosure is generally designated 403. The blank 403 and tray formed therefrom can have one or more features that are substantially similar to those described above with regard to the blank 103 and tray 105 and like or similar features are designated with like or similar reference numerals.

As shown, the blank 303 has the longitudinal axis L1 and the lateral axis L2, the central panel 111, the attachment panels 113, 117, the end panels 121, 123, the side panels 141, 145, and the bottom panels 129, 133, 151, 157.

However, and as illustrated, the notches 122 formed along the flange 120/central panel 111 of the blank 403/tray formed therefrom are laterally offset from their respective positions described above with respect to the blank 103/tray 105. In this regard, the tray 405 formed from the blank 403 can be configured to support the ledges 321, 323 of the tray 305 along the flange 120 of the tray formed from the blank 403 at a position laterally offset from that described and illustrated above with regard to the tray 105.

It will be understood that a liner such as liner L (FIG. 1) can be applied to at least the interior 407 of the tray 405 formed from the blank 403, and can overlie seams/points of intersection between the respective side panels and panels, e.g., such that the tray 405 formed from the blank 403 has leak-resistant properties. The liner L can be applied to one or more portions of the tray 405 formed from the blank 403 in a manner similar to that described above with regard to the blank 103/tray 105, e.g., via the system 217 illustrated in FIG. 2.

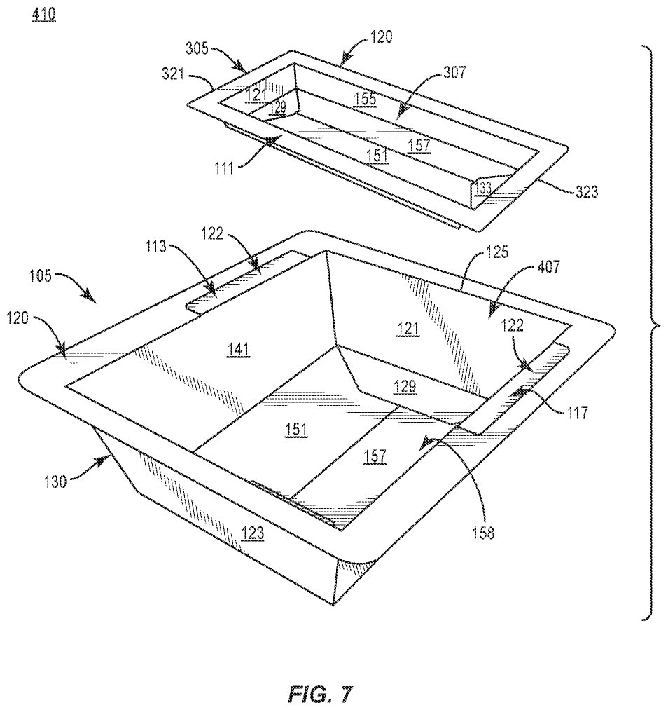

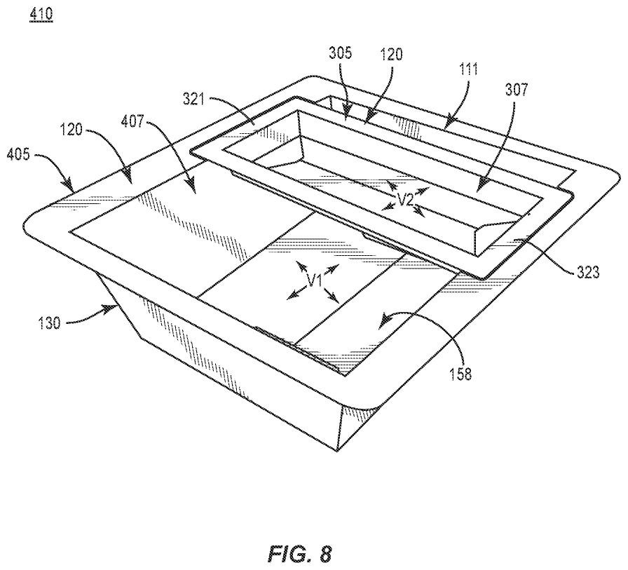

With additional reference to FIGS. 7 and 8, the tray 405 and the tray 305 can be formed and assembled into a system 410 in a manner similar to that described above with respect to the system 110 formed from the tray 105 and the tray 305. However, and as shown, the ledges 321, 323 of the tray 305 can be at least partially received in the respective notches 122 of the tray 405 at a location offset from that in the tray 105.

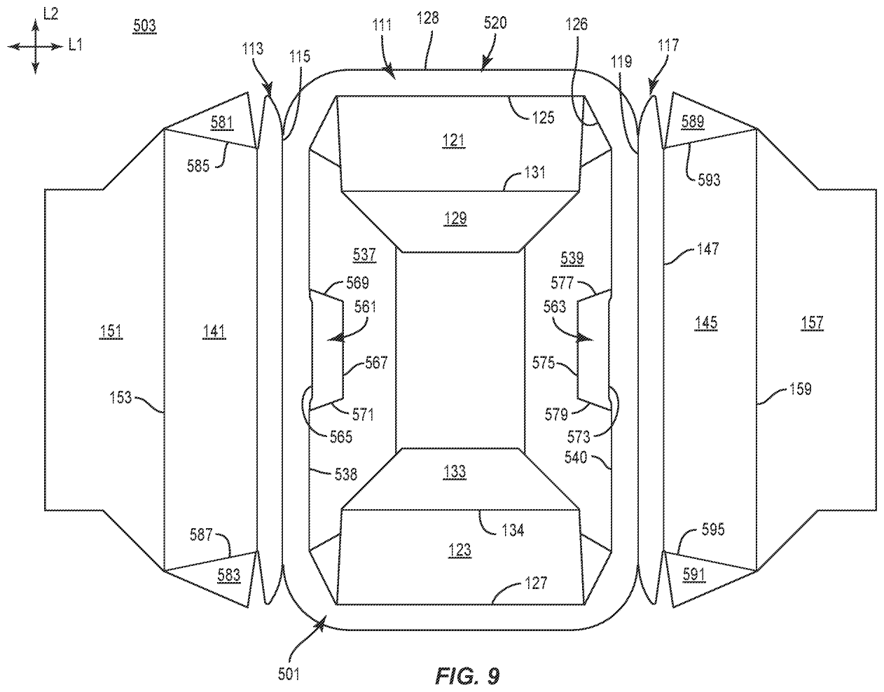

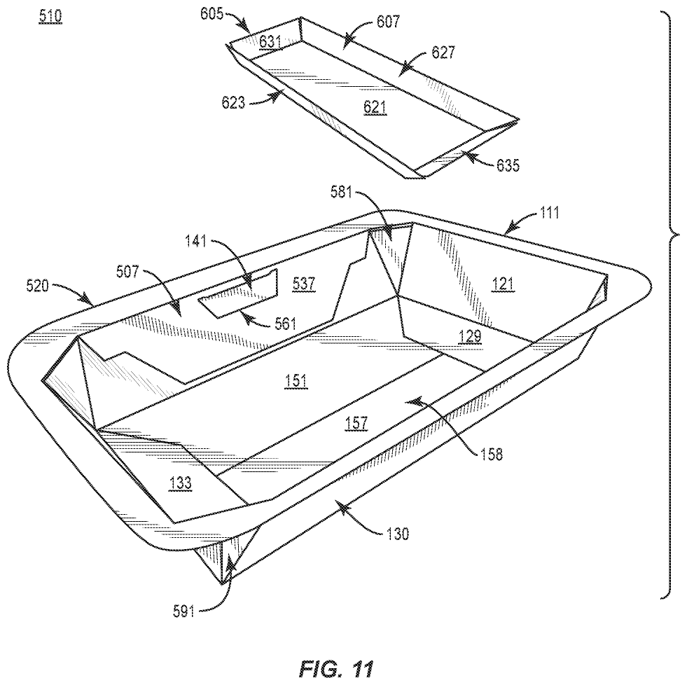

Turning to FIG. 9, an exterior surface 501 of a blank 503 for forming a first tray 505 (FIG. 11) according to a third exemplary embodiment is illustrated. The blank 503 and tray 505 formed therefrom can include one or more features that are the same or similar to those described above with respect to the blanks 103, 403 and trays 105, 405, and like or similar features are designated with like or similar reference numerals.

As shown, the blank 503 can have the longitudinal axis L1 and the lateral axis L2. The blank 503 and tray 505 formed therefrom can include the central panel 111, the first attachment panel 113, the second attachment panel 117, the first end panel 121, the second end panel 123, the first side panel 141, the second side panel 145, the bottom panels 129, 133, 151, 157, and associated features.

Further, the attachment panels 113, 117 of the blank 503 and tray 505 can be devoid of the respective notches 122 and recessed edges 124 therealong. Instead, the blank 503 and tray 505 can be further provided with a first side reinforcement panel 537 and a second side reinforcement panel 539 foldably connected to the central panel 111 at respective lateral fold lines 538, 540. In this regard, the interior edge 126 of the central panel 111 of the blank 503 and tray 505 formed therefrom can be at least partially defined by the fold lines 125, 127, 538, 540.

The blank 503 and tray 505 formed therefrom can also include respective cutouts 561, 563 (broadly, “first cutout” and “second cutout”) defined in the respective side reinforcement panels 537, 539. As shown, the cutout 561 can have a generally trapezoidal configuration, including an upper lateral edge 565, a lower lateral edge 567, and side edges 569, 571 extending obliquely downwardly from endpoints of the upper edge 565 to respective endpoints of the lower edge 567. The upper edge 565 can be positioned interrupting the fold line 538, as shown.

Similarly, the cutout 563 can also have a generally trapezoidal configuration, including an upper lateral edge 573, a lower lateral edge 575, and side edges 577, 579 extending obliquely downwardly from endpoints of the upper edge 573 to respective endpoints of the lower edge 575. The upper edge 573 can be positioned interrupting the fold line 540, as shown. It will be understood that one or both of the cutouts 561, 563 can have a different configuration without departing from the disclosure.

As described herein, one or both of the cutouts 561, 563 and associated edges can be second tray engaging features or compartment forming features of the blank 503/tray 505.

Furthermore, the blank 503 and the tray 505 formed therefrom can include a pair of corner flaps 581, 583 foldably connected to opposed free edges of the side panel 141 at respective oblique fold lines 585, 587, and a pair of corner flaps 589, 591 foldably connected to opposed free edges of the side panel 145 at respective oblique fold lines 593, 595.

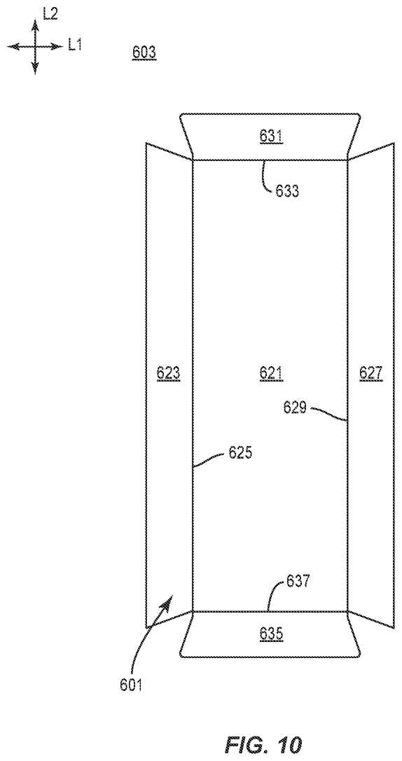

Turning to FIG. 10, an exterior surface 601 of a blank 603 for forming a second tray 605 according to a second exemplary embodiment of the disclosure is illustrated

As shown, the blank 603 can have the longitudinal axis L1 and the lateral axis L2. In the illustrated embodiment, the blank 603 and tray 605 formed therefrom can include a central or bottom panel 621, a first side panel 623 foldably connected to the bottom panel 621 at a lateral fold line 625, a second side panel 627 foldably connected to the bottom panel 621 at a lateral fold line 629, a first end panel 631 foldably connected to the bottom panel 621 at a longitudinal fold line 633, and a second end panel 635 foldably connected to the bottom panel 621 at a longitudinal fold line 637.

The blank 603 and tray 605 formed therefrom can have a different arrangement without departing from the disclosure.

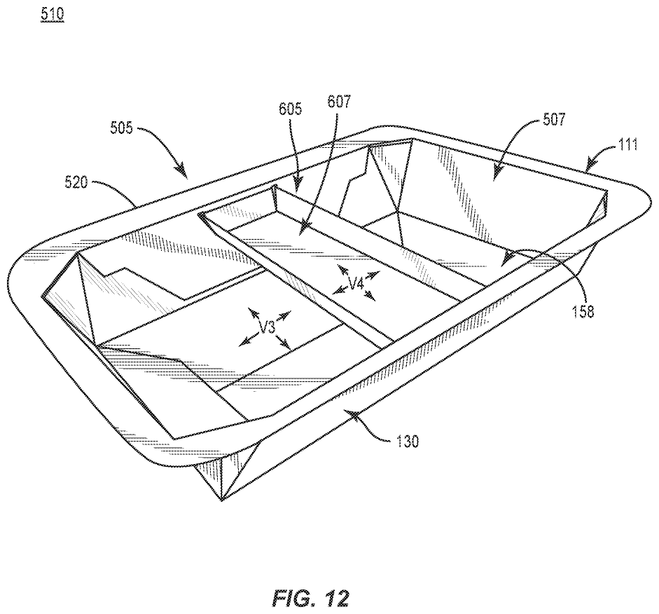

With additional reference to FIGS. 11 and 12, the tray 505 can be formed from the blank 503 in a manner generally similar to that described above with regard to the formation of the tray 105 from the blank 103 and the tray 405 from the blank 403, such that the end panels 121, 123 and side panels 141, 145 at least partially form the sidewall 130 of the tray 505 extending around the interior 507 thereof, and such that the bottom panels 129, 133, 151, 157 at least partially form the bottom wall 158 of the tray 505.

In the illustrated embodiment, the side reinforcement panels 537, 539 can be folded downwardly at the respective fold lines 538, 540 toward the interior 507 of the tray 505 and positioned such that the side reinforcement panels 537, 539 are in at least partial face-to-face contact with respective side panels 141, 145 to provide a two-ply structure therealong to reinforce the tray 505 and provide the tray 505 with a robust construction that resists deformation, bending, crushing etc.

In addition, the corner flaps 581, 589 can be folded at the respective oblique fold lines 585, 593 into at least partial face-to-face contact with respective portions of the end panel 121, and the corner flaps 583, 591 can be folded at the respective fold lines 587, 595 into at least partial face-to-face contact with respective portions of the end panel 123.

It will be understood that, in embodiments, a liner such as liner L (FIG. 1) can be applied to at least the interior 507 of the tray 505, and can overlie seams/points of intersection between the respective side panels, reinforcement panels, and panels, e.g., such that the tray 505 has leak-resistant properties.

The second tray 605 (broadly, “container”) can also be formed from the blank 603 by folding the panels 623, 627, 631, 635 relative to the bottom panel 621 at the respective fold lines 625, 629, 633, 637 such that the panels 623, 626, 631, 635 extend generally obliquely upwardly from the bottom panel 621 and such that the panels 621, 623, 627, 631, 635 extend at least partially around the interior compartment/second compartment/interior 607 of the tray 605. In some embodiments, respective adjacent panels 623, 627, 631, 635 can be attached to one another with an adhesive such as glue, for example, via one or more direct applications of adhesive or via application of adhesive to an attachment flap associated with a respective panel.

Formation of the tray 505 is such that portions of the respective side panels 141, 145 are exposed along the respective cutouts 561, 563, and such that the respective edges associated with the respective cutouts 561, 563 protrude from the respective side panels 141, 145 into the interior 507 of the tray 505. In this regard, the respective lower edges 567, 575 of the respective cutouts 561, 563 can be positioned as ledge-like features for supporting one or more portions of the tray 605.

Accordingly, the tray 505 and the tray 605 can be assembled such that an edge of the tray 605 between the end panel 631 and the bottom panel 621, e.g., proximate the fold line 633, can be supported on the lower edge 567 of the cutout 561, and such that an edge of the tray 605 between the end panel 635 and the bottom panel 621, e.g., proximate the fold line 637, can be supported on the lower edge 575 of the cutout 563, or vice versa.

In such an arrangement, the end panels 631, 635 of the tray 605 can be at least partially circumscribed by the edges of the respective cutouts 561, 563 (or vice versa), such that the end panels 631, 635 of the tray 605 can be at least partially recessed within the walls of the tray 505, e.g., such that the end panels 631, 635 are positioned in a generally coplanar arrangement with respect to the respective reinforcement panels 537, 539 and in at least partial face-to-face contact with the respective side panels 141, 145.

The aforementioned arrangement of the trays 505, 605 can provide a plurality of compartments, e.g., the respective interiors 507, 607 thereof that allow for separation of food products with the advantages described above with respect to the tray 105 and trays 305, 405. In one embodiment, the interior 507 of the tray 505 can define a first interior volume V3 that is greater than a second interior volume V4 defined by the interior 607 of the tray 605. The trays 605, 605 can be provided together as a system 510. In other embodiments, the trays 505, 605 can be considered as being provided in an at least partially nested arrangement.

In one embodiment, a lid/lid structure such as a lidding film T as that described above can be removably attached to the flange 520 of the tray 505, e.g., defined by a portion of the respective central panels 111. Due to the generally recessed disposition of the tray 605 in the interior 507 of the tray 505, the flange 520 of the tray 505 can be generally uninterrupted so as to provide a smooth and planar surface along which the lidding film can be applied to cover the interior 507 of the tray 505 as well as the interior 607 of the tray 605. In some embodiments, a hermetic seal of the interior 507 of the tray 507 and/or the interior 607 of the tray 605 can be achieved by such engagement by a lidding film T.

Any plastic film, such as polyethylene, polypropylene, polyethylene terephthalate, polyvinylchloride, polyamide, and ethylene vinyl alcohol, or other suitable material, can be used for forming the lidding film that is sealed against the sealing surface of the flange 520/central panel 111. Further, adhesives can be used between the lidding film and the sealing surface of the flange/central panel without departing from the disclosure. In one embodiment, the sealing surface of the flange 520 comprises an upper surface of the central panel 111 that is generally free from joints, creases, folds, pleats, edges, and other features that can make sealing a lidding film to the flange more difficult (e.g., that can reduce the smoothness of the flange). Accordingly, the upper surface of the central panel 111 in the trays 105, 305, 505 of the illustrated embodiment can provide a sealing surface superior to that of a container that has features such as pleats or joints on its upper flange surface.

Any of the features of the various embodiments of the disclosure can be combined with, replaced by, or otherwise configured with other features of other embodiments of the disclosure without departing from the scope of this disclosure.

Optionally, one or more portions of the blank or other constructs described herein or contemplated hereby may be coated with varnish, clay, or other materials, either alone or in combination. The coating may then be printed over with product advertising or other information or images. The blanks or other constructs also may be selectively coated and/or printed so that less than the entire surface area of the blank or substantially the entire surface area of the blank may be coated and/or printed.

Any of the blanks, trays, or other constructs of this disclosure may optionally include one or more features that alter the effect of microwave energy during the heating or cooking of a food item that is associated with the tray or other construct. For example, the blank, tray, container, or other construct may be formed at least partially from one or more microwave energy interactive elements (hereinafter sometimes referred to as “microwave interactive elements”) that promote heating, browning and/or crisping of a particular area of the food item, shield a particular area of the food item from microwave energy to prevent overcooking thereof, or transmit microwave energy towards or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular construct and food item.

In the case of a susceptor or shield, the microwave energy interactive material may comprise an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Pat. Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

The use of other microwave energy interactive elements is also contemplated. In one example, the microwave energy interactive element may comprise a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Atlanta, GA) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas may be balanced to attain the desired overall heating characteristics for the particular food item.

As another example, one or more portions of a susceptor may be designed to be microwave energy inactive to ensure that the microwave energy is focused efficiently on the areas to be heated, browned, and/or crisped, rather than being lost to portions of the food item not intended to be browned and/or crisped or to the heating environment. Additionally or alternatively, it may be beneficial to create one or more discontinuities or inactive regions to prevent overheating or charring of the food item and/or the construct including the susceptor.

As still another example, a susceptor may incorporate one or more “fuse” elements that limit the propagation of cracks in the susceptor, and thereby control overheating, in areas of the susceptor where heat transfer to the food is low and the susceptor might tend to become too hot. The size and shape of the fuses may be varied as needed. Examples of susceptors including such fuses are provided, for example, in U.S. Pat. Nos. 5,412,187, 5,530,231, U.S. Patent Application Publication No. US 2008/0035634A1, published Feb. 14, 2008, and PCT Application Publication No. WO 2007/127371, published Nov. 8, 2007, each of which is incorporated by reference herein in its entirety.

All dimensional information presented herein is intended to be illustrative of certain aspects, features, etc., of various embodiments of the disclosure, and is not intended to limit the scope of the disclosure. The dimensions of the blanks, containers, forming tools, features, or any other dimension, can be more or less than what is shown and described in this disclosure without departing from the scope of this disclosure and can be within the listed ranges of dimensions for each feature or outside the listed ranges of dimensions for each feature without departing from the scope of this disclosure.

The blanks according to the present invention can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blanks. The blanks may also be coated with, for example, a moisture barrier layer, on either or both sides of the blanks.

In accordance with the exemplary embodiments, the blanks may be constructed of paperboard of a caliper such that it is heavier and more rigid than ordinary paper. The blanks can also be constructed of other materials, such as cardboard, hard paper, or any other material having properties suitable for enabling the carton package to function at least generally as described above.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A tray for holding one or more food products, the tray comprising:
a plurality of panels comprising a central panel, at least one attachment panel in at least partial face-to-face contact with a portion of the central panel, at least one side panel foldably connected to a respective panel of the plurality of panels, at least one end panel foldably connected to a respective panel of the plurality of panels, and at least one bottom panel foldably connected to a respective panel of the plurality of panels, the at least one side panel intersecting the at least one end panel to at least partially form a sidewall of the tray extending around an interior of the tray, the at least one bottom panel at least partially forming a bottom wall of the tray; and
tray engaging features for at least partially supporting another tray in the interior of the tray.

2. The tray of claim 1, wherein the tray engaging features comprise at least one notch defined along the central panel.

3. The tray of claim 2, wherein the at least one notch is at least partially defined along an interior edge of the central panel.

4. The tray of claim 2, wherein the at least one attachment panel is exposed along the at least one notch for at least partially supporting another tray.

5. The tray of claim 4, wherein the at least one notch is a first notch and the tray engaging features further comprise a second notch at least partially defined along an interior edge of the central panel opposite the first notch.

6. The tray of claim 4, wherein the central panel at least partially extends around an opening, the at least one end panel is foldably connected to the central panel at a first fold line extending along the opening, the at least one attachment panel is foldably connected to the central panel, and at least one side panel is foldably connected to the at least one attachment panel at a second fold line such that the second fold line is spaced apart from the opening.

7. The tray of claim 4, wherein the at least one attachment panel is foldably connected to the central panel, the at least one side panel is foldably connected to the at least one attachment panel, the at least one bottom panel is a first bottom panel foldably connected to the at least one end panel, and the plurality of panels further comprises a second bottom panel foldably connected to the at least one side panel, the first bottom panel and the second bottom panel are in at least partial face-to-face contact to at least partially form the bottom wall of the tray.

8. The tray of claim 7, wherein the at least one attachment panel is a first attachment panel, the plurality of panels further comprises a second attachment panel in at least partial face-to-face contact with the central panel, the at least one side panel is a first side panel foldably connected to the first attachment panel, the plurality of panels further comprises a second side panel foldably connected to the second attachment panel, the at least one end panel is a first end panel foldably connected to the central panel, the plurality of panels further comprises a second end panel foldably connected to the central panel, a third bottom panel foldably connected to the second side panel, and a fourth bottom panel foldably connected to the second end panel,
the first side panel, the second side panel, the first end panel, and the second end panel at least partially forming the sidewall of the tray, the first bottom panel, the second bottom panel, the third bottom panel, and the fourth bottom panel at least partially forming the bottom wall of the tray.

9. The tray of claim 1, wherein the plurality of panels further comprises at least one side reinforcement panel foldably connected to the central panel, the tray engaging features comprising at least one cutout in the at least one side reinforcement panel.

10. The tray of claim 9, wherein the at least one cutout comprises an upper edge, a lower edge, and a pair of side edges extending obliquely from the upper edge to the lower edge.

11. The tray of claim 9, wherein the at least one side reinforcement panel is in at least partial face-to-face contact with the at least one side panel such that a portion of the at least one side panel is exposed along the at least one cutout for at least partially supporting another tray.

12. The tray of claim 11, wherein the at least one side reinforcement panel is a first side reinforcement panel and the plurality of panels further comprises a second side reinforcement panel foldably connected to the central panel, wherein the at least one cutout is a first cutout and the tray engaging features further comprise a second cutout in the second side reinforcement panel.

13. The tray of claim 9, wherein the central panel at least partially extends around an opening, the at least one end panel is foldably connected to the central panel at a first fold line extending along the opening, the at least one attachment panel is foldably connected to the central panel, and at least one side panel is foldably connected to the at least one attachment panel at a second fold line such that the second fold line is spaced apart from the opening.

14. The tray of claim 13, further comprising a liner at least partially overlying the interior of the tray.

15. The tray of claim 9, wherein the at least one attachment panel is foldably connected to the central panel, the at least one side panel is foldably connected to the at least one attachment panel, the at least one bottom panel is a first bottom panel foldably connected to the at least one end panel, and the plurality of panels further comprises a second bottom panel foldably connected to the at least one side panel, the first bottom panel and the second bottom panel are in at least partial face-to-face contact to at least partially form the bottom wall of the tray.

16. The tray of claim 15, wherein the at least one attachment panel is a first attachment panel, the plurality of panels further comprises a second attachment panel in at least partial face-to-face contact with the central panel, the at least one side panel is a first side panel foldably connected to the first attachment panel, the plurality of panels further comprises a second side panel foldably connected to the second attachment panel, the at least one end panel is a first end panel foldably connected to the central panel, the plurality of panels further comprises a second end panel foldably connected to the central panel, a third bottom panel foldably connected to the second side panel, and a fourth bottom panel foldably connected to the second end panel,
the first side panel, the second side panel, the first end panel, and the second end panel at least partially forming the sidewall of the tray, the first bottom panel, the second bottom panel, the third bottom panel, and the fourth bottom panel at least partially forming the bottom wall of the tray.

17. A blank for forming a tray for holding one or more food products, the blank comprising:
a plurality of panels comprising a central panel, at least one attachment panel for being in at least partial face-to-face contact with a portion of the central panel when the tray is formed from the blank, at least one side panel foldably connected to a respective panel of the plurality of panels, at least one end panel foldably connected to a respective panel of the plurality of panels, and at least one bottom panel foldably connected to a respective panel of the plurality of panels, the at least one side panel for intersecting the at least one end panel to at least partially form a sidewall of the tray formed from the blank and extending around an interior of the tray formed from the blank, the at least one bottom panel for at least partially forming a bottom wall of the tray formed from the blank; and
tray engaging features for at least partially supporting another tray in the interior of the tray formed from the blank.

18. The blank of claim 17, wherein the tray engaging features comprise at least one notch defined along the central panel.

19. The blank of claim 18, wherein the at least one notch is at least partially defined along an interior edge of the central panel.

20. The blank of claim 18, wherein the at least one attachment panel is for being exposed along the at least one notch when the tray is formed form the blank for at least partially supporting another tray.

21. The blank of claim 20, wherein the at least one notch is a first notch and the tray engaging features further comprise a second notch at least partially defined along an interior edge of the central panel opposite the first notch.

22. The blank of claim 20, wherein the central panel at least partially extends around an opening, the at least one end panel is foldably connected to the central panel at a first fold line extending along the opening, the at least one attachment panel is foldably connected to the central panel, and at least one side panel is foldably connected to the at least one attachment panel at a second fold line such that the second fold line is spaced apart from the opening.

23. The blank of claim 20, wherein the at least one attachment panel is foldably connected to the central panel, the at least one side panel is foldably connected to the at least one attachment panel, the at least one bottom panel is a first bottom panel foldably connected to the at least one end panel, and the plurality of panels further comprises a second bottom panel foldably connected to the at least one side panel, the first bottom panel and the second bottom panel are for being in at least partial face-to-face contact to at least partially form the bottom wall of the tray formed from the blank.

24. The blank of claim 23, wherein the at least one attachment panel is a first attachment panel, the plurality of panels further comprises a second attachment panel, the at least one side panel is a first side panel foldably connected to the first attachment panel, the plurality of panels further comprises a second side panel foldably connected to the second attachment panel, the at least one end panel is a first end panel foldably connected to the central panel, the plurality of panels further comprises a second end panel foldably connected to the central panel, a third bottom panel foldably connected to the second side panel, and a fourth bottom panel foldably connected to the second end panel,
the first side panel, the second side panel, the first end panel, and the second end panel at for least partially forming the sidewall of the tray formed from the blank, the first bottom panel, the second bottom panel, the third bottom panel, and the fourth bottom panel are for at least partially forming the bottom wall of the tray formed from the blank.

25. The blank of claim 17, wherein the plurality of panels further comprises at least one side reinforcement panel foldably connected to the central panel, the tray engaging features comprising at least one cutout in the at least one side reinforcement panel.

26. The blank of claim 25, wherein the at least one cutout comprises an upper edge, a lower edge, and a pair of side edges extending obliquely from the upper edge to the lower edge.

27. The blank of claim 25, wherein the at least one side reinforcement panel is for being in at least partial face-to-face contact with the at least one side panel when the tray is formed from the blank such that a portion of the at least one side panel is exposed along the at least one cutout for at least partially supporting another tray.

28. The blank of claim 27, wherein the at least one side reinforcement panel is a first side reinforcement panel and the plurality of panels further comprises a second side reinforcement panel foldably connected to the central panel, wherein the at least one cutout is a first cutout and the tray engaging features further comprise a second cutout in the second side reinforcement panel.

29. The blank of claim 25, wherein the central panel at least partially extends around an opening, the at least one end panel is foldably connected to the central panel at a first fold line extending along the opening, the at least one attachment panel is foldably connected to the central panel, and at least one side panel is foldably connected to the at least one attachment panel at a second fold line such that the second fold line is spaced apart from the opening.

30. The blank of claim 29, in combination with a liner for at least partially overlying an interior of the tray formed from the blank.

31. The blank of claim 25, wherein the at least one attachment panel is foldably connected to the central panel, the at least one side panel is foldably connected to the at least one attachment panel, the at least one bottom panel is a first bottom panel foldably connected to the at least one end panel, and the plurality of panels further comprises a second bottom panel foldably connected to the at least one side panel, the first bottom panel and the second bottom panel are for being in at least partial face-to-face contact to at least partially form the bottom wall of the tray formed from the blank.

32. The blank of claim 31, wherein the at least one attachment panel is a first attachment panel, the plurality of panels further comprises a second attachment panel, the at least one side panel is a first side panel foldably connected to the first attachment panel, the plurality of panels further comprises a second side panel foldably connected to the second attachment panel, the at least one end panel is a first end panel foldably connected to the central panel, the plurality of panels further comprises a second end panel foldably connected to the central panel, a third bottom panel foldably connected to the second side panel, and a fourth bottom panel foldably connected to the second end panel,
the first side panel, the second side panel, the first end panel, and the second end panel for at least partially forming the sidewall of the tray formed from the blank, the first bottom panel, the second bottom panel, the third bottom panel, and the fourth bottom panel for at least partially forming the bottom wall of the tray formed from the blank.

33. A method of forming a tray for holding one or more food products, the method comprising:
obtaining a blank comprising a plurality of panels comprising a central panel, at least one attachment panel, at least one side panel foldably connected to a respective panel of the plurality of panels, at least one end panel foldably connected to a respective panel of the plurality of panels, and at least one bottom panel foldably connected to a respective panel of the plurality of panels, and tray engaging features;
positioning the at least one side panel and the at least one end panel to at least partially form a sidewall at least partially extending around an interior of the tray and such that the tray engaging features are positioned for at least partially supporting another tray in the interior of the tray; and
positioning the at least one bottom panel to at least partially form a bottom wall of the tray.

34. The method of claim 33, wherein the tray engaging features comprise at least one notch defined along the central panel.

35. The method of claim 34, wherein the at least one notch is at least partially defined along an interior edge of the central panel.

36. The method of claim 34, further comprising positioning the at least one attachment panel in at least partial face-to-face contact with the central panel such that the at least one attachment panel is exposed along the at least one notch for at least partially supporting another tray.

37. The method of claim 36, wherein the at least one notch is a first notch and the tray engaging features further comprise a second notch at least partially defined along an interior edge of the central panel opposite the first notch.

38. The method of claim 36, wherein the central panel at least partially extends around an opening, the at least one end panel is foldably connected to the central panel at a first fold line extending along the opening, the at least one attachment panel is foldably connected to the central panel, and at least one side panel is foldably connected to the at least one attachment panel at a second fold line such that the second fold line is spaced apart from the opening.

39. The method of claim 36, wherein the at least one attachment panel is foldably connected to the central panel, the at least one side panel is foldably connected to the at least one attachment panel, the at least one bottom panel is a first bottom panel foldably connected to the at least one end panel, and the plurality of panels further comprises a second bottom panel foldably connected to the at least one side panel, the method further comprises positioning the first bottom panel and the second bottom panel in at least partial face-to-face contact to at least partially form the bottom wall of the tray.

40. The method of claim 39, wherein the at least one attachment panel is a first attachment panel, the plurality of panels further comprises a second attachment panel, the at least one side panel is a first side panel foldably connected to the first attachment panel, the plurality of panels further comprises a second side panel foldably connected to the second attachment panel, the at least one end panel is a first end panel foldably connected to the central panel, the plurality of panels further comprises a second end panel foldably connected to the central panel, a third bottom panel foldably connected to the second side panel, and a fourth bottom panel foldably connected to the second end panel,
the method further comprises positioning the first side panel, the second side panel, the first end panel, and the second end panel to at least partially form the sidewall of the tray, the method further comprises positioning the first bottom panel, the second bottom panel, the third bottom panel, and the fourth bottom panel at least partially forming the bottom wall of the tray.

41. The method of claim 33, wherein the plurality of panels further comprises at least one side reinforcement panel foldably connected to the central panel, the tray engaging features comprising at least one cutout in the at least one side reinforcement panel.

42. The method of claim 41, wherein the at least one cutout comprises an upper edge, a lower edge, and a pair of side edges extending obliquely from the upper edge to the lower edge.

43. The method of claim 41, further comprising positioning the at least one side reinforcement panel in at least partial face-to-face contact with the at least one side panel such that a portion of the at least one side panel is exposed along the at least one cutout for at least partially supporting another tray.

44. The method of claim 43, wherein the at least one side reinforcement panel is a first side reinforcement panel and the plurality of panels further comprises a second side reinforcement panel foldably connected to the central panel, wherein the at least one cutout is a first cutout and the tray engaging features further comprise a second cutout in the second side reinforcement panel.

45. The method of claim 41, wherein the central panel at least partially extends around an opening, the at least one end panel is foldably connected to the central panel at a first fold line extending along the opening, the at least one attachment panel is foldably connected to the central panel, and at least one side panel is foldably connected to the at least one attachment panel at a second fold line such that the second fold line is spaced apart from the opening.

46. The method of claim 45, further comprising obtaining a liner and positioning the liner at least partially overlying the interior of the tray.

47. The method of claim 41, wherein the at least one attachment panel is foldably connected to the central panel, the at least one side panel is foldably connected to the at least one attachment panel, the at least one bottom panel is a first bottom panel foldably connected to the at least one end panel, and the plurality of panels further comprises a second bottom panel foldably connected to the at least one side panel, the method further comprising positioning the first bottom panel and the second bottom panel in at least partial face-to-face contact to at least partially form the bottom wall of the tray.

48. The method of claim 47, wherein the at least one attachment panel is a first attachment panel, the plurality of panels further comprises a second attachment panel, the at least one side panel is a first side panel foldably connected to the first attachment panel, the plurality of panels further comprises a second side panel foldably connected to the second attachment panel, the at least one end panel is a first end panel foldably connected to the central panel, the plurality of panels further comprises a second end panel foldably connected to the central panel, a third bottom panel foldably connected to the second side panel, and a fourth bottom panel foldably connected to the second end panel,
the method further comprises positioning the first side panel, the second side panel, the first end panel, and the second end panel to at least partially form the sidewall of the tray, the method further comprises positioning the first bottom panel, the second bottom panel, the third bottom panel, and the fourth bottom panel at least partially forming the bottom wall of the tray.

49. The method of claim 33, wherein the tray formed from the blank is a first tray, the method further comprises obtaining a second tray, and the method further comprises at least partially receiving a portion of the second tray on the tray engaging features of the first tray to at least partially support the second tray in the interior of the first tray.

50. A system, the system comprising:
a first tray comprising:
a plurality of panels comprising a central panel, at least one attachment panel in at least partial face-to-face contact with a portion of the central panel, at least one side panel foldably connected to a respective panel of the plurality of panels, at least one end panel foldably connected to a respective panel of the plurality of panels, and at least one bottom panel foldably connected to a respective panel of the plurality of panels, the at least one side panel intersecting the at least one end panel to at least partially form a sidewall of the tray extending around an interior of the tray, the at least one bottom panel at least partially forming a bottom wall of the tray; and
tray engaging features for at least partially supporting another tray in the interior of the tray; and
a second tray at least partially supported in the interior of the first tray by the tray engaging features.

51. The system of claim 50, wherein the tray engaging features comprise at least one notch defined along the central panel.

52. The system of claim 51, wherein the at least one notch is at least partially defined along an interior edge of the central panel.

53. The system of claim 51, wherein the at least one attachment panel is exposed along the at least one notch and at least partially supporting the second tray.

54. The system of claim 53, wherein the at least one notch is a first notch and the tray engaging features further comprise a second notch at least partially defined along an interior edge of the central panel opposite the first notch.

55. The system of claim 53, wherein the central panel at least partially extends around an opening, the at least one end panel is foldably connected to the central panel at a first fold line extending along the opening, the at least one attachment panel is foldably connected to the central panel, and at least one side panel is foldably connected to the at least one attachment panel at a second fold line such that the second fold line is spaced apart from the opening.

56. The system of claim 53, wherein the at least one attachment panel is foldably connected to the central panel, the at least one side panel is foldably connected to the at least one attachment panel, the at least one bottom panel is a first bottom panel foldably connected to the at least one end panel, and the plurality of panels further comprises a second bottom panel foldably connected to the at least one side panel, the first bottom panel and the second bottom panel are in at least partial face-to-face contact to at least partially form the bottom wall of the first tray.

57. The system of claim 56, wherein the at least one attachment panel is a first attachment panel, the plurality of panels further comprises a second attachment panel in at least partial face-to-face contact with the central panel, the at least one side panel is a first side panel foldably connected to the first attachment panel, the plurality of panels further comprises a second side panel foldably connected to the second attachment panel, the at least one end panel is a first end panel foldably connected to the central panel, the plurality of panels further comprises a second end panel foldably connected to the central panel, a third bottom panel foldably connected to the second side panel, and a fourth bottom panel foldably connected to the second end panel,
the first side panel, the second side panel, the first end panel, and the second end panel at least partially forming the sidewall of the first tray, the first bottom panel, the second bottom panel, the third bottom panel, and the fourth bottom panel at least partially forming the bottom wall of the first tray.

58. The system of claim 50, wherein the plurality of panels further comprises at least one side reinforcement panel foldably connected to the central panel, the tray engaging features comprising at least one cutout in the at least one side reinforcement panel.

59. The system of claim 58, wherein the at least one cutout comprises an upper edge, a lower edge, and a pair of side edges extending obliquely from the upper edge to the lower edge.

60. The system of claim 58, wherein the at least one side reinforcement panel is in at least partial face-to-face contact with the at least one side panel such that a portion of the at least one side panel is exposed along the at least one cutout and at least partially supporting the second tray.

61. The system of claim 60, wherein the at least one side reinforcement panel is a first side reinforcement panel and the plurality of panels further comprises a second side reinforcement panel foldably connected to the central panel, wherein the at least one cutout is a first cutout and the tray engaging features further comprise a second cutout in the second side reinforcement panel.

62. The system of claim 58, wherein the central panel at least partially extends around an opening, the at least one end panel is foldably connected to the central panel at a first fold line extending along the opening, the at least one attachment panel is foldably connected to the central panel, and at least one side panel is foldably connected to the at least one attachment panel at a second fold line such that the second fold line is spaced apart from the opening.

63. The system of claim 62, further comprising a liner at least partially overlying the interior of the first tray.

64. The system of claim 58, wherein the at least one attachment panel is foldably connected to the central panel, the at least one side panel is foldably connected to the at least one attachment panel, the at least one bottom panel is a first bottom panel foldably connected to the at least one end panel, and the plurality of panels further comprises a second bottom panel foldably connected to the at least one side panel, the first bottom panel and the second bottom panel are in at least partial face-to-face contact to at least partially form the bottom wall of the first tray.

65. The system of claim 64, wherein the at least one attachment panel is a first attachment panel, the plurality of panels further comprises a second attachment panel in at least partial face-to-face contact with the central panel, the at least one side panel is a first side panel foldably connected to the first attachment panel, the plurality of panels further comprises a second side panel foldably connected to the second attachment panel, the at least one end panel is a first end panel foldably connected to the central panel, the plurality of panels further comprises a second end panel foldably connected to the central panel, a third bottom panel foldably connected to the second side panel, and a fourth bottom panel foldably connected to the second end panel,
the first side panel, the second side panel, the first end panel, and the second end panel at least partially forming the sidewall of the first tray, the first bottom panel, the second bottom panel, the third bottom panel, and the fourth bottom panel at least partially forming the bottom wall of the first tray.

66. The system of claim 58, wherein the second tray comprises a flange at least partially received in the at least one cutout of the first tray.

67. The system of claim 58, wherein the first tray is spaced above the bottom of the second tray.

68. The system of claim 58, wherein the first tray defines an interior volume that is larger than an interior volume defined by the second tray.
